(19) United States
(12) Patent Application Publication
(10) Pub. No.: US 2005/0002291 A1
(43) Pub. Date: Jan. 6, 2005

(54) Method and apparatus for head positioning control in a disk drive

(75) Inventor: Kenji Takeuchi, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/871,378

(22) Filed: Jun. 21, 2004

(30) Foreign Application Priority Data
Jul. 1, 2003 (JP) 2003-189672

(51) Int. Cl. G11B 7/00

(52) U.S. Cl. 369/44.29; 369/44.34

(57) ABSTRACT

A head positioning control system applied to a disk drive is disclosed. The head positioning control system includes a combination of a feedback control unit and a feedforward control unit. During a maximum seek operation, the system uses a saturated value estimating unit to estimate a saturated value for an actuator. The system then sets the saturated value in a variable limiter of the feedforward control unit.

### CROSS-REFERENCE TO RELATED APPLICATIONS

This application is based upon and claims the benefit of priority from prior Japanese Patent Application No. 2003-189672, filed Jul. 1, 2003, the entire contents of which are incorporated herein by reference.

### BACKGROUND OF THE INVENTION

1. Field of the Invention

The present invention generally relates to a disk drive, and in particular, to head positioning control comprising a combination of feedback control and feedforward control.

2. Description of the Related Art

In general, a head positioning control system is incorporated in a disk drive typified by a hard disk drive. The head positioning control system controls an actuator including a voice coil motor (VCM) to position a head at a target position on a disk medium (hereinafter simply referred to as a disk).

Owing to its structure or the like, a motor such as the VCM of the actuator cannot output a torque of an infinite magnitude. That is, the actuator (in a narrow sense, the VCM), a control object (plant) of the head positioning control system, has a limit (saturation) on its output.

In a conventional system, a saturated value for the control object is assumed to be fixed, and a limiter using the fixed saturated value is incorporated into a controller. Specifically, the limiter is incorporated into a VCM driver that controls the VCM. The incorporation of the limiter enables such a design as avoids a situation in which the control object is destroyed when the system outputs an excessive control manipulated variable (a control input value input to the control object) to the control object.

In an actual design, when a fixed limiter value (fixed saturated value) that is a specification for the limiter is determined, the actual apparatus is used to measure the maximum and minimum values of a current required to drive the actuator. Further, a plurality of actuators of the same structure are used to calculate the average of measurements to determine a fixed limiter value.

However, the saturated value has been confirmed to vary with environmental conditions such as temperature and voltage. In the prior art, for safety, the limiter is designed using a saturated value obtained under unfavorable conditions under which saturation is most likely to occur. Thus, if the saturated value is assumed to vary significantly with the environmental conditions, the limiter is designed to have a relatively small saturated value. Therefore, even under normal environmental conditions, it may disadvantageously be impossible to make the most of the output characteristic of the actuator.

Further, in a system controlling the control object having the saturation characteristic is composed of a feedback control system having an integration element, as in the case of the previously described actuator, the following problems may occur. The limitation on the control manipulated variable (control input value) may cause the amount of control (for the disk drive, the position of the head) performed on the control object to overshoot markedly is or vibrate as the time passes. That is, a windup phenomenon is likely to occur.

Well-known control methods of suppressing the windup phenomenon include a method of resetting the integration once the input to the limiter exceeds the saturated value and a method of feeding back the deviation between the input to and output from the limiter to converge the integration input to zero.

In connection with this, it is effective to use a control system comprising a combination of the above latter method with a method of estimating the saturation characteristic of the actuator, which varies with the external environmental conditions such as a variation in temperature, voltage, and humidity (for example, refer to Jpn. Pat. Appln. KOKAI Publication No. 2001-195102).

However, the control method disclosed in this prior art document requires the following arithmetic operation for each control sample: the operation of using a saturated value estimating function to estimate the maximum and minimum values of the saturation characteristic on the basis of environmental information obtained from the control object. This requires a CPU, the main element of the head positioning control system of the disk drive, to execute an increased amount of arithmetic processing at an increased speed. Thus, disadvantageously, a CPU with a high arithmetic processing capability is required.

To reduce the load on the CPU, it is contemplated that the amount of arithmetic processing to be executed by the CPU to calculate the saturated value may be reduced by pre-calculating the relationship between a variation in external environment and the saturation characteristic and storing the result of the calculation as table information. However, this method requires a mass memory that stores the table information or complicated operations for acquiring the table information. Further, in particular, even the same actuators may exhibit differences. Disadvantageously, fixed table information cannot deal with this situation.

### BRIEF SUMMARY OF THE INVENTION

In accordance with an aspect of the present invention, there is provided a disk drive which performs head positioning control that reliably controls an actuator having a saturation characteristic varying with an external environment without imposing an excessive arithmetic load on a CPU.

The disk drive comprises an actuator mechanism which moves a head in a radial direction of a disk medium; and a head positioning control unit which controls the actuator mechanism to position the head at a target position on the disk medium. The head positioning control unit comprises a saturated value estimating unit which calculates a saturated value for the actuator mechanism when a maximum seek operation is performed in which the head is moved over a range corresponding to a maximum movement distance on the disk medium, a memory which stores the saturated value calculated by the saturated value estimating unit, a feedforward control unit to which the saturated value stored in the memory is input to calculate a feedforward compensation value when the head is positioned at the target position on the disk medium, and a feedback control unit which controls the actuator mechanism in accordance with feedback control using a control manipulated variable calculated based on the saturated value and the feedforward compensation value input from the feedforward control unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a block diagram showing the configuration of a head positioning control system according to an embodiment of the present invention;

FIG. 2 is a block diagram showing essential parts of a disk drive according to this embodiment;

FIG. 3 is a flowchart illustrating the procedure of head positioning control according to this embodiment;

FIG. 4 is a flowchart according to another embodiment; and

FIG. 5 is a block diagram showing the configuration of a head positioning control system according to the embodiment shown in FIG. 4.

### DETAILED DESCRIPTION OF THE INVENTION

Embodiments of the present invention will be described with reference to the drawings.

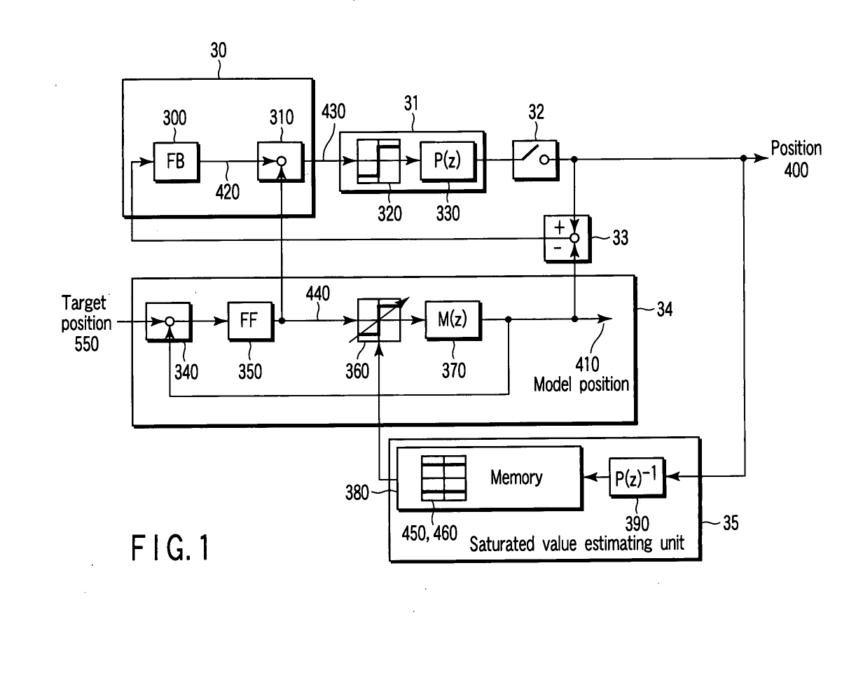

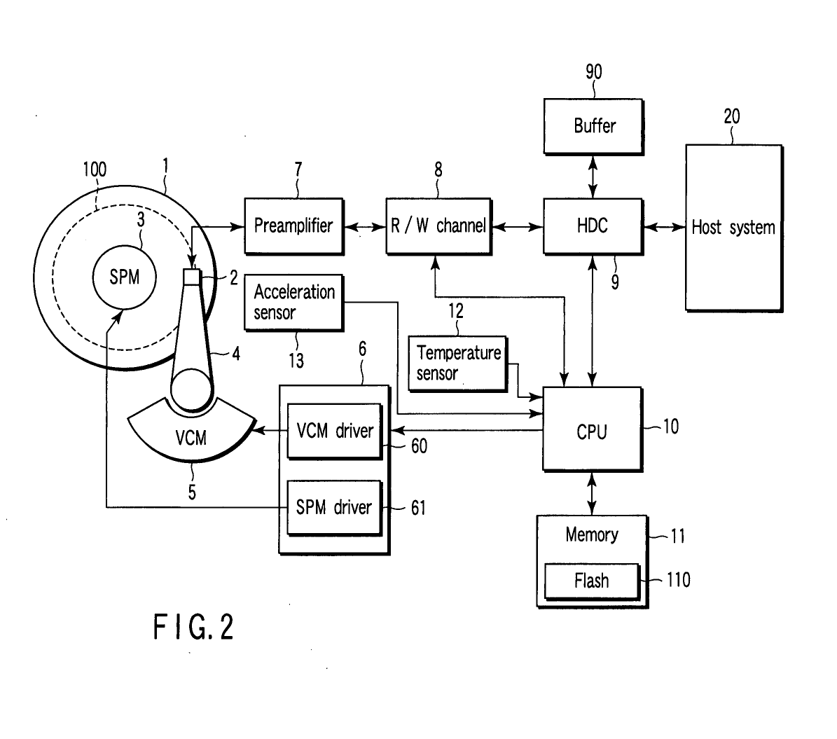

FIG. 1 is a block diagram showing the conceptual configuration of a head positioning control system according to the present embodiment. FIG. 2 is a block diagram showing essential parts of a disk drive according to the present embodiment.

(Configuration of Disk Drive)

The disk drive has a disk 1 that is a magnetic recording medium and a magnetic head (hereinafter simply referred to as a head) that performs a data read or write operation on the disk 1, as shown FIG. 2. The disk 1 is rotated by a spindle motor (SPM) 3.

The head 2 is mounted on an actuator 4 including a voice coil motor (VCM) 5. A VCM driver 60 included in a motor driver IC 6 supplies a driving current to the VCM 5. The motor driver IC 6 includes an SPM driver 61 as well as the VCM driver 60 and is controlled by a CPU 10.

The head 2 comprises a read head that performs a read operation and a write head that performs a write operation; the read head and the write head are mounted on a slider. The actuator 4 is controlled by a head positioning control system using the CPU 10 as the main element so that the head 2 is moved to a target position on the disk 1, as described later.

Moreover, the disk drive comprises a circuit system having a preamplifier 7, an R/W channel 8, a disk controller (HDC) 9, the CPU 10, and a memory 11.

The preamplifier 7 has a read amplifier that amplifies a read signal output by the read head as well as a write amplifier. The write amplifier converts a write data signal output by the R/W channel 8 into a write current signal and dispatches the converted signal to the write head. The. R/W channel 8 is a signal processing IC that processes read/write data signals (including servo data signals).

The HDC 9 has an interface function to interface the drive with a host system 20 (for example, a personal computer or digital equipment). Specifically, the HDC 9 manages a buffer memory 90 to control the transfer of read/write data between the disk 1 and the host system 20. The buffer memory 90 is a DRAM that temporarily stores read/write data.

The CPU 10 is the main control device of the drive and of the head positioning control system. The memory 11 includes a RAM and a ROM in addition to a flash memory (EEPROM) 110 that is a nonvolatile memory. The memory 11 saves various data and programs required to control the CPU 10.

Moreover, the disk drive has a temperature sensor 12 and an acceleration sensor 13. The temperature sensor 12 detects the temperature in the drive and outputs the temperature value to the CPU 10. Further, the acceleration sensor 13 detects the acceleration of the actuator 4, driven by the VCM 5. The acceleration sensor 13 then outputs the acceleration value to the CPU 10.

(Head Positioning Control System)

The head positioning control system according to the present embodiment is a control system (2-degree-of-freedom control system) comprising a combination of a feedback control system with a feedforward control system. This system is incorporated into the disk drive and is implemented mainly by the CPU 10 and the R/W channel 8.

The present system assumes the actuator 4 (actually the VCM 5), having a saturation characteristic, to be a control object 31. The present system controls the actuator 4 to position the head 2 at a target position 550. Here, the control object 31 includes a limiter 320 that limits a control input (control manipulated variable), in addition to the actuator 4 (VCM 5), that is, a control object (plant) 330 in a narrow sense. The limiter 320 is actually incorporated into the VCM driver 60.

As shown in FIG. 1, the present system is roughly composed of blocks including a feedback control unit 30, a feedforward control unit 34 having a variable limiter 360 inside, and a saturated value estimating unit 35.

The feedback control unit 30 includes a feedback controller (referred to as an FB controller) 300 and an adder 310. The FB controller 300 calculates a control manipulated variable 420 used to eliminate a difference between position information 400 on the head detected by a position sensor 32 and model position information 410 described later.

The adder 310 adds the control manipulated variable 420 to a feedforward control manipulated variable 440 (hereinafter referred to as an FF compensation value) calculated by a feedforward controller (hereinafter referred to as an FF controller) 350. The adder 310 then outputs a control manipulated variable 430 obtained to the control object 31.

The position sensor 32 is specifically a position detecting unit included in the R/W channel 8. The position sensor 32 calculates the position information 400, indicating the position of the head 2, from the operational state of the plant 330. The adder 33 calculates a difference between the position information 400 and the model position information 410, output by the feedforward control unit 34.

The feedforward control unit 34 has an adder 340 to which a target position 550 is input, an FF controller 350, a variable limiter 360, and a control object model 370. The control object model 370 is a mathematic model of the plant 330, included in the control object 31. The adder 340 calculates a difference between the model position information 410, obtained from the model 370, and the target position 550 of the actual plant 330.

The FF controller 350 calculates the FF compensation value 440, used to eliminate the difference between the target position 550 and the model position 410. The variable limiter 360 executes the same limitation process as that executed on the saturation characteristic of the actuator 330 of the control object 31, on the control manipulated variable, the FF compensation value 440. The variable limiter 360 then outputs the value obtained to a control object model 370.

Here, for the feedforward control unit 34, the control object model 370 is a feedback controlled variable. That is, the feedforward control unit 34 executes feedback control independently of the control object 31 so that the control object model position 410 is the same as the target position 550. The feedforward control unit 34 inputs this FF compensation value 440 (FF control manipulated variable) to the control object 31.

The saturated value estimating unit 35 has a memory 380 and an observer 390. The observer 390 is composed of a mathematic model constituting an inverse model of the plant 330. The saturated value estimating unit 35 calculates a saturated value for the plant 330 from the position information 400, detected by the sensor 32. That is, the position information 400 is assumed to contain the saturated value for the plant 330. The observer 390 calculates an acceleration value from the position information 400. The observer 390 then estimates the saturated value for the plant 330 from the acceleration value. In this case, the saturated value contains a saturation upper limit value 450 and a saturation lower limit value 460. The saturated value is stored in the memory 380.

(Procedure of Head Positioning Control)

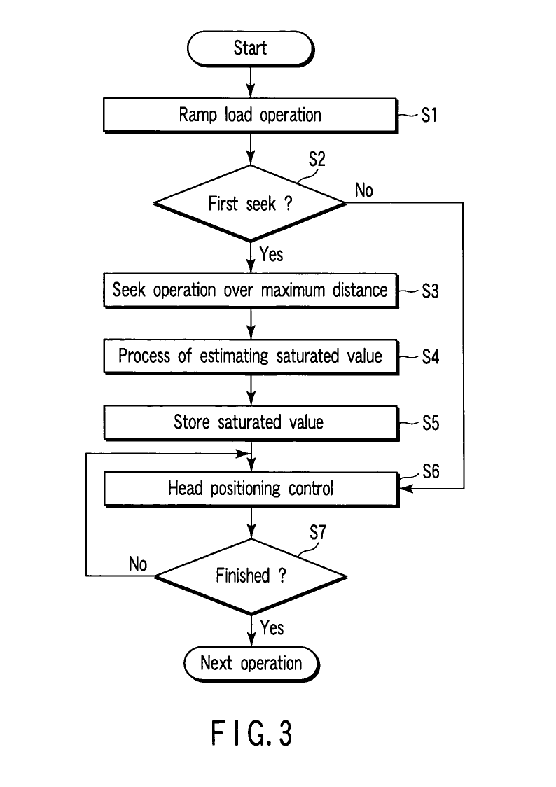

With reference to the flowchart in FIG. 3, in addition to FIGS. 1 and 2, description will be given below of the procedure of head positioning control according to the present embodiment.

First, the disk drive is powered on. Then, the CPU 10 performs a normal ramp load operation (parking operation) to move the head 2 to a ramp member (parking ramp) provided outside the disk 1 (step S1). The ramp load operation withdraws the head 2 from the disk 1 during a non-read/write operation.

Then, the CPU 10 performs a first seek operation (also referred to as a first seek) before a seek operation for a read/write operation (YES in step S2; step S3). The first seek operation moves the head 2 from an outside position (ramp member) of the disk 1 to its most inner peripheral position. This stabilizes the floating posture of the head 2 on the disk 1.

The first seek operation is a seek over the maximum distance (also referred to as the maximum seek operation) in which the head 2 moves from most outer periphery to most inner periphery on the disk 1. Accordingly, the control manipulated variable 420 calculated by the CPU 10 (FB controller 300) has the largest value among all the seek operations. That is, the largest current is supplied to the VCM 5 (plant 330), included in the actuator.

Here, during the maximum seek operation, the CPU 10 (FB controller 300) may calculate a control manipulated variable exceeding the saturation characteristic of the actuator (VCM 5). Thus, as shown in FIG. 1, the control object 31 is provided with the limiter 320 to limit the control manipulated variable (control input value) taking the saturated value into account.

In the system (CPU 10) according to the present embodiment, the saturated value estimating unit 35 uses the observer 390 to calculate the saturated value using the position information 400 (the current position of the head 2), obtained from the sensor 32 (R/W channel 8) (step S4). Specifically, the observer 390 is composed of the mathematic model constituting the inverse model of the plant 330. The observer 390 uses the position information 400, detected by the sensor 32, to estimate the control manipulated variable input to the plant 330 during the maximum seek operation.

The saturated value estimating unit 35 stores, in the memory 380, the saturation upper limit value 450 and saturation lower limit value 460, contained in the saturated value calculated by the observer 390 (step S5). After the maximum seek operation has been completed, the process executed by the saturated value estimating unit 35 to estimate the saturated value is finished. Then, the feedforward control unit 34 sets the saturated value in the variable limiter 360, the saturated value having been saved to the memory 380 and containing the saturation upper limit value 450 and the saturation lower limit value 460. An initial value for the variable limiter 360 is large enough to avoid producing an adverse effect on the estimation of the saturated value. This allows the saturated value for the control object 330 to be accurately estimated.

With the above procedure, for example, during the first seek immediately after power-on, the saturated value (450 and 460) for the actuator (VCM 5), the control object 330, is estimated. The value is then set in the variable limiter 360 of the feedforward control unit 34. After this processing, the procedure shifts to a normal head positioning control operation performed by the system comprising the combination of the FB control system 30 and the FF control system 34, shown in FIG. 1 (steps S6 and S7).

That is, the FF controller 350 calculates the FF compensation value 440, used to eliminate the difference between the target position 550 and the model position 410. The target position 550 is a target track position of a read/write target on the disk 1. The head 2 is to be positioned at the target track position.

As previously described, on the basis of the saturated value set by the saturated value estimating unit 35, the variable limiter 360 executes the same limitation process as that executed on the saturation characteristic of the actuator 330 of the control object 31, on the control manipulated variable, the FF compensation value 440. The variable limiter 360 then outputs the value obtained to a control object model 370.

In the feedback control unit 30, the FB controller 300 receives the difference between the model position information 410 and the position information 400 on the control object 330 output by the adder 33. The feedback control unit 30 adds the control manipulated variable 420 to the FF control manipulated variable 440. The feedback control unit 30 then controllably outputs the result 430 to the control object 31. With this system, even with disturbance or a modeling error, it is possible to provide such control as precisely follows the motion of the ideal model (370).

In short, according to the present embodiment, in the system comprising the combination of the feedforward control unit 34 and the feedback control unit 30, the saturated value for the actuator, the control object, is calculated during the maximum seek operation such as the first seek. Accordingly, in contrast to a method of calculating the saturated value for each control sample, this method calculates the saturated value during the particular period when the maximum seek operation is performed. This makes it possible to reduce the arithmetic load on the CPU 10 when it calculates the saturated value.

Moreover, when the calculated saturated value is set in the variable limiter 360 of the feedforward control unit 34, the feedforward control unit 34 can implement a compensation function in response to a variation in the saturation characteristic of the actuator. Consequently, it is possible to make the most of the actuator's capabilities without causing a windup phenomenon as in the case of the prior art.

Further, since the feedforward control unit 34 has the variable limiter 360, it can be designed independently of the feedback control unit 30. It is further possible to easily design the feedforward control unit 34 that can prevent the windup phenomenon or make the windup phenomenon unlikely to occur.

(Alternate Embodiment Relating to Saturated Value Estimating Method)

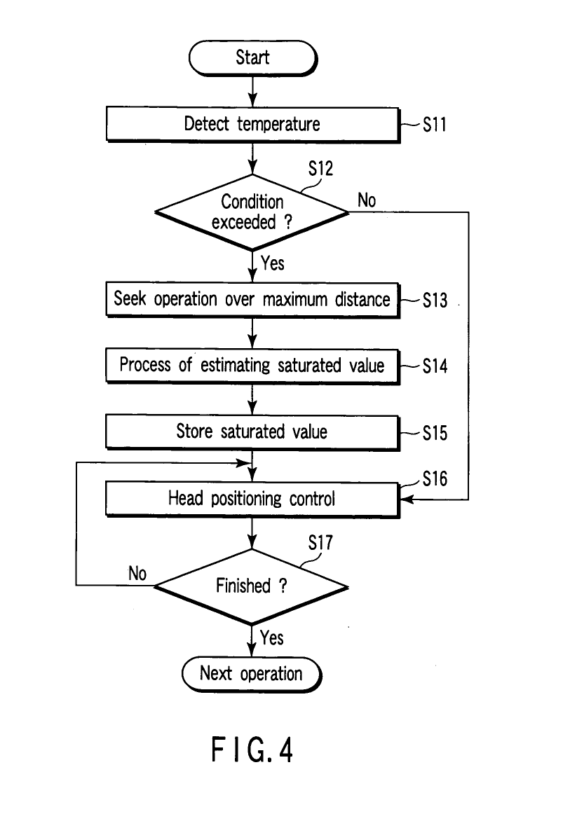

FIG. 4 is a flowchart showing a method of estimating the saturated value which method is executed by the saturated value estimating unit 35 according to the present embodiment.

In recent years, a disk drive has been used as a storage device for digital equipment mounted in, for example, an automobile. In such a use environment, the ambient temperature of the disk drive may vary rapidly with the temperature of the air. Thus, the saturation characteristic of the actuator in the drive may vary drastically with the temperature.

The method of the present embodiment updates the setting of the variable limiter 360 of the head positioning control system in response to a variation in the saturation characteristic of the actuator accompanying a variation in temperature. A specific procedure will be described below with reference to the flowchart in FIG. 4.

First, as shown in FIG. 2, temperature detected values from the temperature sensor 12, provided in the drive, are input to the CPU 10 at predetermined intervals (step S11). Thus, the CPU 10 monitors a variation in temperature. Upon determining that the temperature has varied enough to affect the saturation characteristic of the actuator, the CPU 10 executes the previously described process of estimating the saturated value (YES in step S12).

Then, during a non-read/write operation, the CPU 10 performs the maximum seek operation, in which the head 1 performs a seek operation from most outer periphery to most inner periphery of the disk 1 or from most inner periphery to most outer periphery of the disk 1 (step S13. During the maximum seek operation, the saturated value estimating unit 35 uses the observer 390 to calculate the saturated value using the position information 400 obtained from the sensor 32 (step S14).

The saturated value estimating unit 35 stores, in the memory 380, the saturation upper limit value 450 and saturation lower limit value 460, contained in the saturated value calculated by the observer 390 (step S15). Then, the feedforward control unit 34 sets the saturated value in the variable limiter 360, the saturated value having been saved to the memory 380 and containing the saturation upper limit value 450 and the saturation lower limit value 460. That is, the set value for the variable limiter 360 is updated in response to a variation in the saturation characteristic of the control object 330.

With the above procedure of the present embodiment, during the maximum seek operation accompanying the detection of a variation in temperature, the saturated value (450 and 460) for the actuator (VCM 5), the control object 330, is estimated. The value is then set in the variable limiter 360 of the feedforward control unit 34. After this processing, the procedure shifts to a normal head positioning control operation performed by the system comprising the combination of the FB control system 30 and the FF control system 34, shown in FIG. 1 (steps S16 and S17).

In general, a variation in an environmental condition such as temperature does not occur so rapidly but gradually. Accordingly, in the present variation, the CPU 10 uses a boundary condition based on temperature detected values from the temperature sensor 12 to determine a variation in the saturation characteristic of the actuator. Thus, the CPU 10 need not update the saturated value for each predetermined sampling. Instead, the CPU 10 properly calculates and updates the saturation upper limit value and the saturation lower limit value in response to a variation in temperature. This makes it possible to reduce the arithmetic load on the CPU 10 and suppress power consumption.

(Alternate Embodiment Relating to Saturated Value Estimating Method)

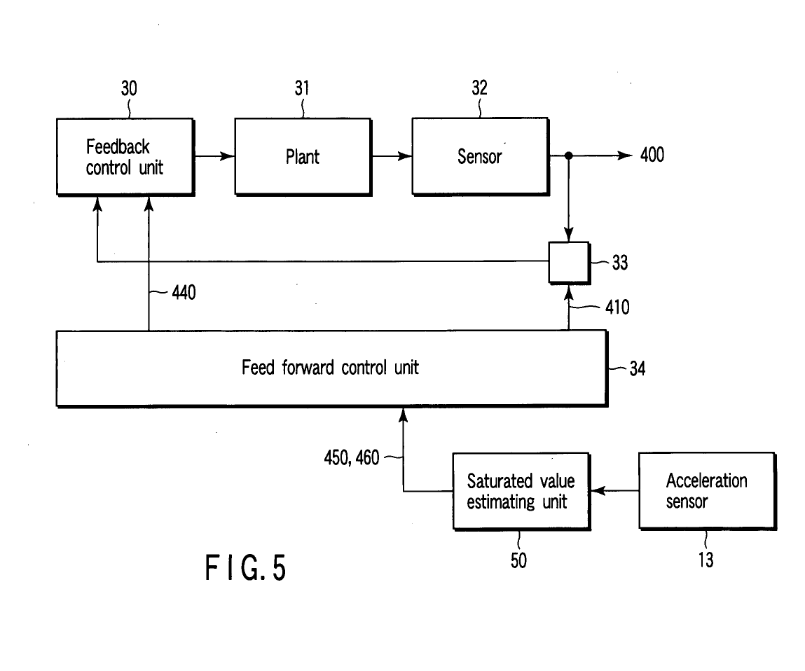

FIG. 5 is a block diagram showing the head positioning control system according to the present embodiment.

The present embodiment provides a system having the saturated value estimating unit 50 that estimates, during the maximum seek operation (for example, the first seek), the saturated value using an acceleration value detected by the acceleration sensor 13 and without using the position information 400 on the control object. The observer 390 according to the present embodiment calculates the acceleration value from the position information 400. The observer 390 then estimates the saturated value for the plant 330 from the acceleration value.

As shown in FIG. 5, the CPU 10 uses the acceleration sensor 13 to detect the value of acceleration accompanying the movement of the actuator 4 or head 2. The saturated value estimating unit 50 according to the present variation uses the acceleration value detected by the acceleration sensor 13 during the maximum seek operation to calculate the saturated value for the actuator (VCM), the control object. The saturated value estimating unit 50 then stores the saturation upper limit value 450 and saturation lower limit value 460, contained in the saturated value, in the memory 380.

As shown in the flowchart in FIG. 3 or FIG. 4, the saturated value estimating unit 50 according to the present variation calculates the saturated value for the control object during the first seek or during the maximum seek operation accompanying a variation in temperature.

As described above in detail, according to the present and alternate embodiments, it is possible to provide a disk drive that performs head positioning control that reliably controls an actuator having a saturation characteristic varying with an external environment without imposing an excessive arithmetic load on a CPU.

Specifically, in a head positioning control system comprising a combination of a feedback control system and a feedforward control system, the saturated value for the actuator, a control object, is estimated during a maximum seek operation. Thus, the actuator is controlled in accordance with the saturation characteristic, which varies with the external environment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A disk drive comprising:
an actuator mechanism which moves a head in a radial direction of a disk medium; and
a head positioning control unit which controls the actuator mechanism to position the head at a target position on the disk medium,
wherein the head positioning control unit comprises:
a saturated value estimating unit which calculates a saturated value for the actuator mechanism when a maximum seek operation is performed in which the head is moved over a range corresponding to a maximum movement distance on the disk medium;
a memory which stores the saturated value calculated by the saturated value estimating unit;
a feedforward control unit to which the saturated value stored in the memory is input to calculate a feedforward compensation value when the head is positioned at the target position on the disk medium; and
a feedback control unit which controls the actuator mechanism in accordance with feedback control using a control manipulated variable calculated based on the saturated value and the feedforward compensation value input from the feedforward control unit.

2. The disk drive according to claim 1, wherein the head positioning control unit includes a detecting unit which detects an operational state of the actuator mechanism, and
the saturated value estimating means is an observer which calculates an acceleration value from the operational state of the actuator mechanism detected by the detecting means in accordance with the maximum seek operation and which calculates the saturated value in accordance with the acceleration value.

3. The disk drive according to claim 1, wherein the head positioning control unit includes a position detecting unit which detects a position of the head depending on an operation of the actuator mechanism, and
the saturated value estimating unit is an observer which calculates the saturated value on the basis of position information output by the position detecting unit in accordance with the maximum operation.

4. The disk drive according to claim 1, wherein the feedforward control unit has a model following control unit which calculates a feedforward control manipulated variable corresponding to the feedforward compensation value on the basis of a difference between the target position and a position of a control object model; and
a variable limiter which sets the saturated value output by the saturated value estimating unit, which limits the feedforward control manipulated variable on the basis of the saturated value, and which outputs the limited feedforward control manipulated variable to the control object model.

5. The disk drive according to claim 1, wherein the saturated value estimating unit calculates the saturated value that is a maximum saturated value or minimum saturated value for a saturation characteristic of the actuator mechanism, in accordance with the maximum seek operation.

6. The disk drive according to claim 1, wherein the saturated value estimating unit calculates the saturated value during a non-read/write operation in accordance with a maximum seek operation of moving the head from most outer peripheral area to most inner peripheral area on the disk medium or a maximum seek operation of moving the head in the opposite direction.

7. The disk drive according to claim 1, wherein the head positioning control unit includes a unit which performs, during a non-read/write operation and in association with a variation in temperature, a maximum seek operation of moving the head from most outer peripheral area to most inner peripheral area on the disk medium or a maximum seek operation of moving the head in the opposite direction, and
the saturated value estimating unit calculates the saturated value in accordance with the maximum seek operation accompanying the variation in temperature.

8. The disk drive according to claim 1, wherein the head positioning control unit includes an acceleration sensor which detects an acceleration of a motor included in the actuator mechanism, and
the saturated value estimating unit calculates the saturated value in accordance with the acceleration value detected by the acceleration sensor in accordance with the maximum seek operation.

9. A method of head positioning control applied to a disk drive having a head which records or reproduces data on or from a disk medium and an actuator mechanism on which the head is mounted and which moves the head in a radial direction of the disk medium, the method comprising:
during a non-read/write operation, controlling the actuator mechanism to perform a maximum seek operation of moving the head over a range corresponding to a maximum movement distance on the disk medium;
calculating a saturated value for the actuator mechanism in accordance with the maximum seek operation;
storing the saturated value in a memory;
calculated by the saturated value estimating unit;
when the head is positioned at the target position on the disk medium, controlling the actuator mechanism by performing feedback control that using a control manipulated variable calculated based on the saturated value and feedforward control which calculates a feedforward compensation value.

10. The method according to claim 9, wherein the calculation of the saturated value comprises calculating an acceleration vale from an operational state of the actuator mechanism in accordance with the maximum seek operation and calculating the saturated value in accordance with the acceleration value.

11. The method according to claim 9, wherein the calculation of the saturated value comprises calculating the saturated value on the basis of position information indicative of a position of the head accompanying the maximum seek operation.

12. The method according to claim 9, wherein the calculation of the saturated value comprises calculating the saturated value that is a maximum saturated value or minimum saturated value for a saturation characteristic of the actuator mechanism, in accordance with the maximum seek operation.

13. The method drive according to claim 9, wherein the performance of the maximum seek operation comprises performing a maximum seek operation of moving the head from most outer peripheral area to most inner peripheral area on the disk medium or a maximum seek operation of moving the head in the opposite direction.

14. The method according to claim 9, wherein the performance of the maximum seek operation comprises performing a maximum seek operation of moving the head from most outer peripheral area to most inner peripheral area on the disk medium or a maximum seek operation of moving the head in the opposite direction, during a non-read/write operation in accordance with a variation in the temperature of periphery or interior of the disk storage device.
